(19) United States
(12) Patent Application Publication
(10) Pub. No.: US 2008/0140732 A1
(43) Pub. Date: Jun. 12, 2008

(54) Method and system for sharing file based data

(75) Inventors: Samuel W. Wilson, Downingtown, PA (US); Keith Bentley, Elverson, PA (US); Josh Schifter, Exton, PA (US)

Correspondence Address: VENABLE LLP, P.O. BOX 34385, WASHINGTON, DC, 20043-9998, US

(73) Assignee: Bentley System, Inc., Exton, PA (US)

(21) Appl. No.: 11/636,654

(22) Filed: Dec. 11, 2006

(51) Int. Cl. G06F 17/30; G06F 12/00; G06F 9/44

(52) U.S. Cl. 707/201; 707/203; 717/168; 707/E17.01; 707/E17.007

(57) ABSTRACT

A method for resolving conflicts between versions of a file is provided. User input defining a boundary defining a conflict area are received. Conflicts between versions of a file are detected based on changes made to elements within the conflict area. The conflicts are marked in one of the versions of the file. The one version of the file is saved as the current version, including the conflicts. The other version of the file is saved in a history.

### FIELD OF THE INVENTION

The invention relates to a system and method for concurrently sharing file based data among a plurality of users.

### BACKGROUND OF THE INVENTION

The goal of concurrent engineering is to enable multiple users to work on the same design concurrently, each contributing his own expertise in a way that builds on and complements the work of others. Engineering projects present a particularly challenging computer information management problem since they are characterized by workflows that involve multiple participants simultaneously making changes to related information. Current generation software products, particularly those in the computer aided drafting (CAD) category, are weak at supporting these workflows, since they were generally designed to replicate and automate the one-at-a-time nature of drafting boards.

In pre-CAD workflows, a paper drawing could only be modified by a single draftsperson at a time. Thus, it seemed natural that the computerized equivalents would take the same approach. However, that approach is now seen as inadequate. First, the manual process on which the software design is based has limitations and problems. For example, coordination between draftspeople requires verbal communication between the draftspeople, which is subject to a breakdown. Second, the ‘ubiquitous’ nature of electronic information access tends to exacerbate the weaknesses of the manual communications process. Participants on an electronic project can now be physically dispersed as a byproduct of the ‘virtual office’ model made possible by communications advances such as the Internet. Third, software advances are making electronic engineering simulations more powerfull and reliable such that the computer model can be regarded as the master design information, with design drawings representing reports generated from that model.

To simplify the data management task, most engineering design tools store each model in its own physical file. The main drawback of this approach, in a multi-user setting, is that it imposes a fixed limit on how users can collaborate on a project. By mapping the design concept of a model to the operating system concept of a file, these tools impose file system concepts and limitations on the structure and flow of design work. This is a bad fit in several respects.

Current file-oriented tools commonly do file-level locking, which permits only one user to modify anything pertaining to a given model at a given time. The Microsoft Windows network file system is a simple example of a document control system with pessimistic locking. In engineering design work, a change to an existing design or the further development of a design can commonly take several days and involve a number of smaller steps. In some cases, changes may affect large parts of the project. A single engineer may therefore keep a given set of design files locked and out of circulation for long periods of time, blocking the progress of other users whose changes may require write access to one or more of those files. Clearly, current file-oriented approaches become a bottleneck to teamwork. Equally clearly, even if the unit of information sharing and change-control could be broken down, it would be inappropriate to apply traditional multi-user transaction concurrency rules, which assume relatively quick, isolated changes.

Current file-oriented approaches also do not adequately address the problem of how to merge the collaborative work of many users on many files into a coherent change to the project. An entity, such as an architect, may be involved with many ongoing projects with overlapping scope. Accordingly, a set of documents affected by project A might overlap with a set of documents affected by project B. These documents are often “as-built” drawings. The same as-built drawings are used and modified independently in the course of each of these projects. As each project completes, it returns up-dated as-built drawings. The remaining projects need to get updates to the as-builts, without losing or having to re-draw their own changes to those drawings.

Additionally, project-oriented work requires both sharing and isolation of changes. It is often necessary for several users to work together as a team on a given project. Meanwhile other teams may be working on other projects. The projects often have overlapping scope. While project A is in progress, users within the team must be able to share results with each other. The work-in-progress should not be shared with other teams, until completion or some other significant point is reached. Meanwhile, project B might be completed while project A is still in progress. When project B completes, its changes must be propagated to a master document. Then, working documents in project A must be updated to reflect the changes made by project B, without losing the on-going changes made by project A.

It is not always possible to break areas of responsibility out into separate files. When the changes required to complete two or more projects involve an overlapping set of files, then users can be hindered by hand-off problems and can even lose work. “Maintenance” work affecting many drawings is hindered if users exclusively lock individual drawings.

By limiting concurrency, the file-oriented approach does simplify the problem somewhat (assuming that file sharing is used correctly to prevent collisions and loss of work in the first place). However, when change is limited to one-at-a-time access to files, there is no chance to express and maintain the interdependencies that exist between files, since it could potentially require that all files be locked in order to make a change to any one if the ultimate scope of the change is not known at the outset.

Therefore, the file-oriented approach is to permit these inconsistencies, and require manual inspection by a “higher power” (usually an individual responsible for “project management”) to rectify them. In most cases, merging is done “by eye” during sign-off.

It would be beneficial if “business logic” that enforces standards and design constraints could be integrated into the editing process. The need for automatic methods of verification becomes greater as concurrency is increased.

The merge problem is one aspect of the general problem of documenting, managing, limiting, and potentially reversing the evolution of a design, which is made more complicated when multiple designers are working on it at the same time. Another aspect of this problem is keeping an infallible log of changes, so that they can be subsequently reviewed when questions arise. If the unit of change is per-file, then change documentation is harder to do in a sufficiently detailed fashion, and harder to integrate into the editing process itself to guarantee an accurate and useful audit trail. Add-on products such as workflow managers and product data managers (PDM) do not address this problem of granularity.

Existing Solutions

One proposed solution is ProjectBank from Bentley Systems. ProjectBank enables users to gain shared access to information without having to resort to pessimistic locking. This approach extracts information from files into a common object database. Users work with objects (indirectly), and change-merging is done on objects. ProjectBank and similar object database systems force users to abandon the use of files, in favor of a new object-based technology. As a result, users may not be able to leverage any of their existing file-oriented tools and systems

Concurrent Versions System (CVS) and similar version-control systems allow users to work on a common set of files and to merge their changes without pessimistic locking. However, CVS and similar version-control systems do not handle binary engineering data, and have a weak concept of “conflicts”.

Live change-replication systems are known and replicate one user's work in the session of another user immediately and synchronously Live change-replication systems do not support offline work. Live change replication systems have the disadvantage of it being disruptive and disadvantageous to have another's work injected synchronously into a user's session as the user works.

The Oracle database system provides a long transaction mechanism. The Oracle database system works only on data that is stored in a database and does not directly support engineering data stored in CAD files. In order to use a database to support collaborative work on CAD data, the data would have to be translated into and out of database format. Such translation may cause data loss and other problems.

Another database approach, for example, in ModelServer Continuum.™, is to store all elements of all models together in a single relational database and to produce temporary design files from the database in order to conduct a viewing or editing session. In addition to providing for better management of shared information, this approach has the benefit of making engineering data more accessible to enterprise applications. The main drawbacks to this approach are that (a) it requires mapping engineering design data into database management system (DBMS) constructs, which is not always easy, (b) it requires a separate database management product to be purchased, installed, and administered, and (c) extraction is done once and for all at the start of the session (i.e., everything for the session must be extracted “up-front”). Some of these products, such as Continuum.™, do address the need for a new concurrency model, but are limited by the capabilities of the underlying database management system.

The problem of mapping engineering data into a database format is severe, since the data models of engineering and DBMS tools were developed independently with different goals. It would be a major benefit to avoid the translation problem without losing the interoperability benefits of this approach.

### SUMMARY OF THE INVENTION

Embodiments of the invention provide a method comprising: creating a local copy at a local computer of a shared file; receiving user input at the local computer modifying the local copy; updating the local copy with changes made to the shared file since the local copy was created; detecting conflicts between the local copy and the changes made to the shared file; marking the conflicts in the local copy; updating the shared file to include changes made to the local copy without requiring the conflicts to be resolved, the local copy replacing the conflicts in the shared file; storing the conflicting version of the shared file in a history.

Further embodiments of the invention provide a method for sharing and isolating changes made to shared files, comprising: creating at least one shared file that is accessible to plural users; creating at least one second tier arranged in a hierarchical fashion under the shared file, the second tier including at least a first file and a second file, which are copies of the shared file, the first and second files being accessible to plural users; linking the first and second files to the shared file; creating a local copy of the first file on a client device; editing the local copy of the first file at the client device; committing the edited copy to the first file, without changing the second file; committing a changed version of the first file to the shared file; and subsequently updating the second file to reflect changes made to the shared file.

Further embodiments of the invention provide a method for resolving conflicts between versions of a file, comprising: receiving user input defining a boundary defining a conflict area; detecting conflicts between versions of a file based on changes made to elements within the conflict area; marking the conflicts in one of the versions of the file; saving the one version of the file as the current version, including the conflicts; and saving the other version of the file in a history.

A computer readable medium storing computer code causing a computer to perform the method steps is also contemplated.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an example of a system according to an exemplary embodiment of the present invention;

FIG. 2 depicts an example of a refresh process according to an exemplary embodiment of the present invention;

FIG. 3 depicts an example of a commit process according to an exemplary embodiment of the present invention;

FIG. 4 depicts an example of a patch file according to an exemplary embodiment of the present invention;

FIG. 5 depicts an example of nested projects according to an exemplary embodiment of the present invention;

FIG. 6 depicts another example of nested projects according to an exemplary embodiment of the present invention;

FIG. 7 depicts an example of updating files in nested projects according to an exemplary embodiment of the present invention;

FIG. 8 depicts an example of committing files in nested projects according to an exemplary embodiment of the present invention; and

FIGS. 9 and 10 depicts an example of updating files in another project according to an exemplary embodiment of the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. Moreover, an embodiment of the invention in the context of engineering design files is provided below. However, the invention is not limited to engineering design files and may be applied to other environments. A person skilled in the relevant art will recognize that other components and configurations can be used without parting from the spirit and scope of the invention.

A typical CAD project employed in the engineering context is stored in numerous files. Some projects include hundreds of files. Each file typically contains one or more engineering models, each of which represents an engineering domain (e.g., structural, electrical, mechanical, plumbing). Moreover, each engineering model requires numerous items represented by a series of elements to support the complex and precise nature of each design. Each item in a model is represented by at least one element or an aggregation of elements. For example, a structural drawing can include the column and beam layout for a floor plan, which are internally represented by lines, squares and rectangles and additional properties.

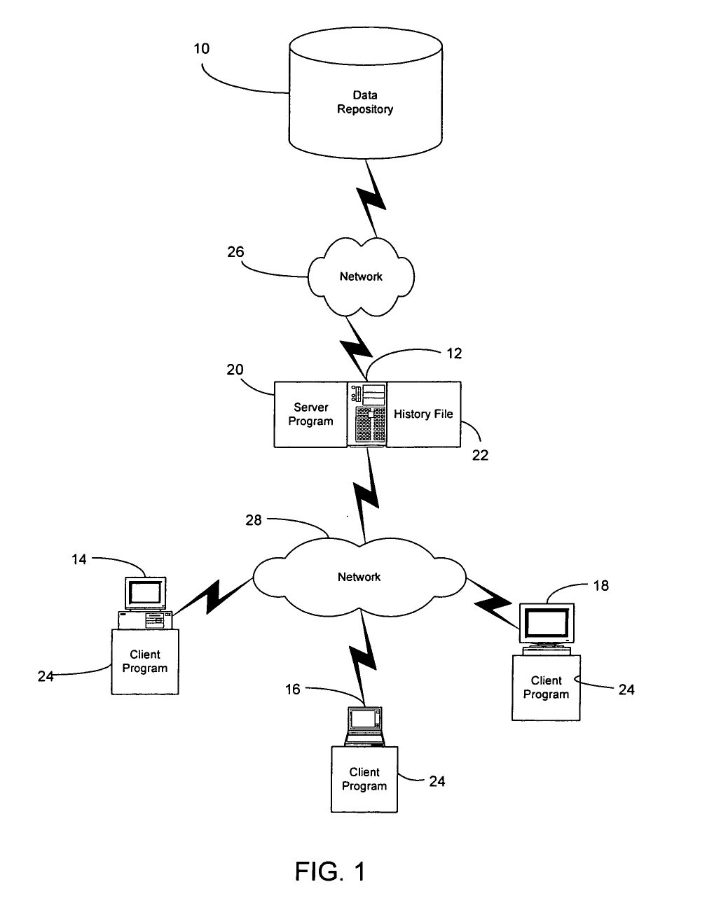

CAD projects and files may be accessed by multiple users working concurrently on the design. Systems that allow multi-user access to the same information can be client-server systems, which are well known to those skilled in the art. In such a system, for example as shown in FIG. 1, a repository 10 accessible via a server 12 may store information or data, such as file based project data, relating to a project. The repository may maintain a current, master copy of the data. Design files on the server may be marked as “shared.” Multiple users, i.e., clients 14-18, may copy or “check out” the “shared” design files to their local devices at the same time. No one user checking out a design file should lock out other users from checking out the same design file. However the master copy should always reside in the repository 10. After the data is copied to the client, it may be changed or modified by the different users. To become a part of the master copy, any changes or modifications to the data should be saved to the repository 10.

Embodiments of the invention may be implemented as software programs running on the server 12 and clients 14-18. These two programs may be loaded into memory and executed on the same user computer, or they can be loaded on two different computers and connected by a computer network 26, 28, or they can be combined into a single program. The server program 20 is the central hub for controlling access to the file based project data in repository 10, and for coordinating and recording changes to the file based project data. The server program 20 executes on a server 12. For a given project, there should be one server program 12 available over a computer network 28. The server program 12 may create, open, operate on, and maintain the data repository 10. Preferably, the data repository 10 is a single file or a controlled collection of files containing the files that comprise the current version of the project. However, the data store can also be some other form of long-term storage facility such as a structured store or a relational database. The server program 12 also creates, opens, and operates on and maintains a project history file 22, which contains a list of all changes made to files in the project.

No other program or computer should directly access the repository 10 or the project history file 22. Instead, users on individual client devices 14-16 execute client programs 24, which connect to the server program 20 to obtain or change files. Client programs 24 execute locally on an individual user's client device 14-18. The file based data is provided from the repository 10 to the client device.

When a user checks out a shared file, the client 14-18 asks the server 12 for a local copy of the file. This local copy may be essentially a copy of the shared file, except that the local copy also may store information that ties the local copy back to the shared file, and may not contain the design history of the shared file. Design files and projects may be arranged in a hierarchical or tiered fashion, as is described in more detail below. In the hierarchy, devices may serve as both clients and servers.

The information that ties the local copy of the design file to a shared file either at the server or at a higher level in the hierarchy may take different forms. In embodiments of the invention, the information that ties the local copy back to the shared file may include a token, a work file definition, and a work file branch. The token uniquely identifies the shared file on the server. The token may simply be a unique ID, such as a number.

The workfile definition may include information regarding the local copy of the design file. In embodiments of the invention, the workfile definition holds information that can be used by the server to check that the client is referring to the correct shared file, that the shared file has not been replaced by some other file, and shared file's history has not been deleted or structurally changed. The workfile definition may include the time that the shared file began tracking its history, that is, tracking actions taken with respect to the shared file. The workfile definition may also include an identifier, such as an integer, issued by the server for this particular copy of the shared design file.

The workfile definition may also include information regarding identifiers for tentative elements or models that may be added to the local copy of the design file during editing, but not yet added to the shared file. Tentative elements and models are described in more detail below. A number, for example, a 64 bit integer, indicating the start of tentative element identifiers in this local copy may be included in the workfile definition. A number, for example, a 32 bit integer. indicating the start of tentative model identifiers in this local copy may also be included.

The workfile branch may include information regarding the shared copy of the design file. The workfile branch may include the revision number that identifies the “tip” state of the shared file when the local copy was made and the time that the tip revision in the shared file was created. The revision number identifies a revision in the design history.

This information tying the local copy of the design file may be used by the client and server in uploading and downloading changes made to the file and in verifying that the local file is a valid local copy of the shared file, as is described in more detail below.

Locally Created Elements

Elements in a design file, and preferably every element, may have a unique ID within that design file. This ID may be an 8-byte integer value. When a user creates a new element in a local copy of a shared file, the client program 24 may assign a unique ID to the new element. This locally assigned ID is considered to be tentative. There may be nothing to prevent the same ID from being issued for new elements created in another local copy of the same shared file. All that is necessary to preserve integrity is that the locally created element have a unique ID within the shared file at the time that the new element is sent to update the shared file.

To support this function, before sending new elements to the server, the client may first make a count of how many new elements are created in the local copy, and may ask the server to reserve that many permanent IDs in the shared file. The server may update a last-issued-ID value that is stored in the shared file in order to reserve IDs. The client may then change the tentative ID of each locally created element to a value in the range of permanent IDs that it received from the server. The new elements at the client do not need to be assigned permanent IDs that are sequential or in any particular order. Locally created references to the new element by other elements should be updated to reflect the permanent ID.

The server may be temporarily locked when reserving IDs, thus ensuring that each client that requests a range of permanent IDs receives a distinct set of values. Therefore, newly created elements in each copy of a shared file appear eventually in the master shared file with distinct IDs. This is a well-known way of solving the unique key problem. The more common approach used by on-line transaction processing applications is to request a unique key from the server at the time that the local element is created, but that is expensive in a WAN environment and is generally not at all suited to complex, long-term CAD transactions.

Update Server Copy

When a user makes a change to the local copy, the client program 24 marks the affected elements. Local changes are not necessarily sent to the shared file at that time, but are kept local until the user elects to update the shared file.

There are many known ways to update a shared file with changes made to copies of this file. In embodiments of the invention, the client tracks the changes made to the local copy of the file. The changes are sent to the server, which updates the shared file to reflect the changes. According to a specific embodiment, of the invention, the client program 24 may send to the server the following to up date the shared file: 1) workfile definition and workfile branch information from the local copy of the file, and 2) local changes made to the file, including a) a list of the elements changed, each element identified by its unique ID within the design file and the type of change; and b) copies of the data for the new and modified elements, preferably in a compressed format. The types of changes that may be made to the file include: added, deleted, and replaced elements. All of this information maybe sent in the form of a temporary file.

When the server receives an update shared file request from a client, the server updates the shared file to reflect the changes. In embodiments of the invention, the server first validates the workfile definition and workfile branch information of the local copy. The workfile definition may be validated by verifying that 1) the identifier for each element is in the range of IDs issued for the shared file, and 2) the time the local file was created matches the shared file's actual history create time. This verification ensures that the client is working with a valid local copy of the shared file. If the shared file is re-created or modified since the local copy was made, then the local copy becomes invalid and cannot be used. The workfile branch information may be validated by verifying that the branch revision number is equal to the shared file's current tip revision number and that the revision time matches the time that the branch revision was actually created in the shared file. This validation ensures that the local copy is based on the very latest version of the shared file. The revision time test also may ensure that the shared file was not re-created since the local copy was created.

If the server validates the “update shared file” request from the client, the server patches the shared file, replicating the changes submitted by the client. The changes may be recorded in the history 22 of the shared file. The tip revision number of the shared file is incremented. Replicating changes is described in more detail below. The shared file may be temporarily locked during this validating and patch procedure. No other local copies can be created and no other clients can update the server copy while this lock is held. Clients may be allowed to request server changes for refreshing purposes while this lock is held, since the client is asking for changes up to a known historical revision.

Refreshing

When shared file is updated, all other local copies based on the shared file become out of date. For example, when the tip revision of the shared file is incremented, a local copy that is based on the previous tip becomes a branch.

The client program 24 cannot update the shared copy of the file with local changes unless the local copy reflects all changes that were committed by other users to the shared file since the local file copy was created (or was most recently refreshed). In other words, if a local file copy becomes a branch, the local copy must merge with the new revision in the shared file and become based on the new tip.

Bringing a local copy up to date with the latest changes to the shared file is called “refreshing” the local copy. In embodiments of the invention, refreshing may be accomplished as follows. The client may request all changes made to the shared file since the local copy was made. The changes that fit this category may be determined by comparing the revision number of the local copy to the revision number of the shared file. The server may respond by sending the new tip revision number and time, plus the changes made to the shared file since the local copy was created. The server may use the same format to transmit changes to the client as the client uses to transmit changes to the server. The client may then attempt to patch the local copy to replicate the changes made to the shared file. The client then updates the revision number and time the revision was created in the workfile branch information stored in the local copy, indicating that the local copy is now based on that revision of the shared file.

During the patching operation, design rules may be applied to the elements in the files during a “change replay” phase in order to maintain consistency across elements. For example, user 1 may change element A in their local copy of a file and commit the change to the shared file. User 2 may add element B to their local copy of the file. Elements A and B are related in some way. If user 1 had known about the addition of element B by user 2, user 1 would have changed element B in the same way he changed element A. Likewise, if user 2 had known about the change user 1 made to element A, user 2 would have created element B to be consistent with element A. User 2 now updates their local copy to include the changes made by user 1 to the shared file. User 2 must now change element B to be consistent with element A. Otherwise, element B does not conform to the design rules and user 2's file is invalid.

A handler may be provided for each element. The handler knows the design rules that apply to that type of element. For each element that is changed in the shared file and in the local copy, the handler checks for consistency problems. For example, the handler can compare different elements of the same type and determine if the elements comply with the applicable design rules. If elements of the same type are inconsistent, the handler can modify the elements to comply with the design rules for that element type and restore design integrity. Related elements that were not previously changed in the shared file or local file may be changed by the handler to achieve consistency.

Consistency issues often come up when “styles” are used to control the appearance of elements and when the styles and the controlled elements contain redundant copies of the same data. When a parameter of the style is changed, the corresponding parameter of the element is modified to match the changed parameter. Referring to the example above, user 1 might have changed a style that controls element A. User 1's change modifies both the style itself and element A. Meanwhile, suppose user 2 creates a new element B that refers to the same style as element A. When replicated into user 2's workfile, user 1's change to the style must be propagated to element B. This is done by the change replay method of element B's handler.

The problem of maintaining consistency rules is not limited to styles. Consistency issues may arise almost any time that several elements must be maintained in some kind of relationship. The change replay phase allows handlers to address the issue.

Note that refreshing the local copy is done at the client. The results of refreshing become part of the local copy of the file. Refreshing a given local copy does not affect other local copies of the same shared file, and refreshing a local copy does not change the shared file itself.

Conflicts

Elements may have been changed in both the shared file and the local file since the local file was created. There are two possibilities for elements in this category: compatible change and conflicting change. Compatible changes occur when different aspects of the same file are changed, but those changes do not affect the same ‘unit of change’. Conflicting changes occur when changes do affect the same units of change. Unit of change is discussed in more detail below.

For those elements with conflicting change, the conflicting changes are not replicated in the local copy. Instead, conflicts are recorded for the elements affected by the server changes. Thus, in the event of a conflict, the user's local changes are preserved. Note that the work of the previous user to the conflicting elements is recorded in the design history 22 for the shared file. Therefore, neither user's work is lost. In this manner, embodiments of the invention provide a process for documenting and tracking conflicts. A user does not need to accept or reject one version of the design in order to synchronize or commit their changes to the shared file. If a local change conflicts with the changes made to the shared filed, both versions of the file are saved. The fact that a conflict has occurred is noted, but neither work in the shared filed nor in the local file is lost.

An important aspect of detecting conflicts is the logic used to determine if two versions of an element are the same. This logic typically compares the two versions of the element's data. This comparison can be complicated by the existence of redundant data contained in multiple elements. Consider a case of two elements E1 and E2, where a property of E2, for example the color, is constrained by the design rules to be equal to the color of E1. In this case, the color of E1 is termed a ‘redundant property’. If user A modifies the color of E1, this will necessarily change the redundant color data that is stored in E2. Finally, user B modifies some other property of E2. Superficially, both users have changed the data in E2. However, users do not consider this situation to be a conflicting change. In practice, such a conflict can be avoided by amending the comparison logic such that it will ignore changes to the redundant properties. Those conflicts based solely on changes to redundant properties may be filtered out and not presented to the user.

Design history tools, such as those in ProjectBank or MicroStation, may be provided to allow the user to see previous versions of the shared file and to examine conflicts. Changes to the shared file and conflicts are recorded in a linear manner, avoiding confusing branches of the shared file with different and conflicting changes. The process for storing the different versions of the design and recording conflicts is described in more detail below.

A conflict may be recorded by creating a conflict element in the local copy of the design file. The conflict element may contain the identity of the element that is the subject of the conflict, plus a copy of the element's last-known data. The copy of the element's data can be used to display the conflict, even after the actual element has been deleted. A conflict persists in the design file, until it is removed by a user. The element that is the subject of the conflict may be changed again after the conflicting element is created. A new conflict element may be created by the refresh process every time a new change to a locally changed element is detected. When conflicts are transmitted to the server by the client, all locally created conflicts should be netted out, and at most a single new conflict sent. When a user removes a conflict, the conflict element may be deleted.

Once the local copy of a file is refreshed as described above, the shared file may be updated to include the changes made to the local copy of the file. If the local changes include conflict elements, then the local version of the elements may be transmitted to the server and become the new tip version. Those conflicting elements in the tip revision of the shared file are replaced with the new version of those elements. Other users who refresh or create new local copies see the updated version. Nevertheless, the previous version of the conflicting elements is stored in the previous revision of the shared file's design history, so that it can be viewed and recovered. Furthermore, the fact that these changes resulted in conflicts is recorded in the shared file, and those conflicts can be reviewed by anyone. Conflicts can persist in the shared file over time, until they are reviewed and removed by a user. Removing previously created conflicts may be done like any other change. The user creates a local copy of the shared file, removes the conflict elements, and updates the server copy with those changes.

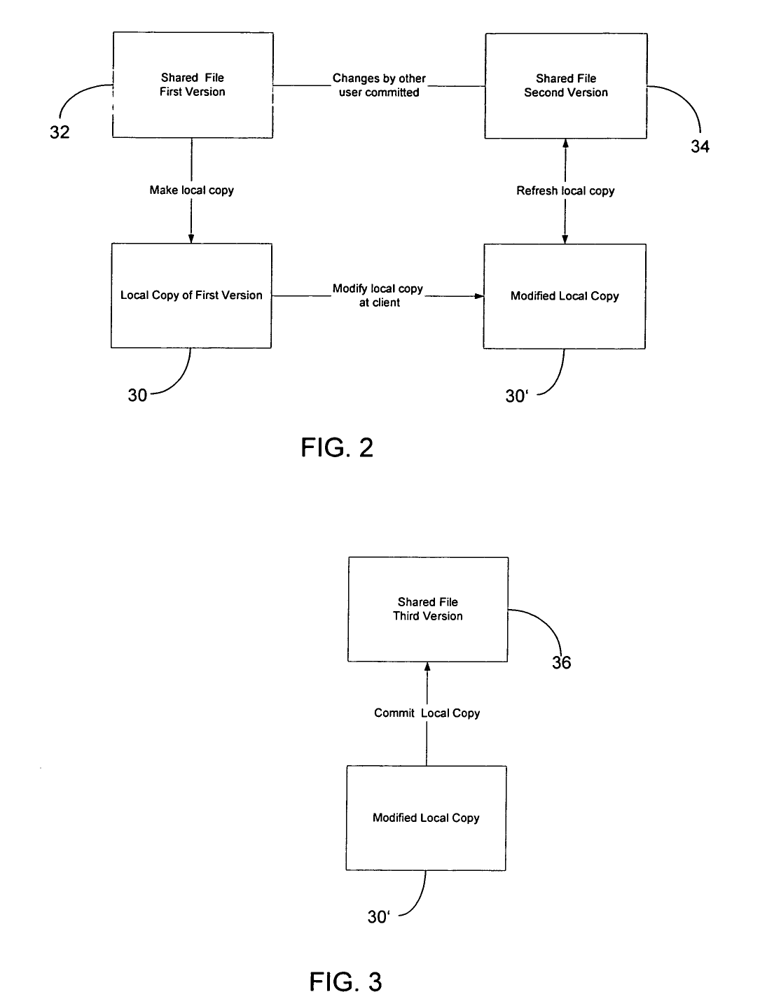

Referring to FIGS. 2 and 3, assume a user creates a local copy 30 of a first version of shared file 32. The first version 32 of the shared file is modified by a previous user. The previous user saves their changes to the shared file and creates a second version 34 of the shared file. Meanwhile, the current user is currently working on certain aspects of the design in local copy 30 creating a modified local copy 30′. The local copy 30′ is based on the first version 32 of the shared file. When the current user attempts to synchronize and commit their changes to the shared file, the changes made in the second version 34 are downloaded to the client. The changes between the second version 34 and local copy 30′ are detected, indicating conflicting elements. The second user may decide not to resolve the conflicts and instead to proceed with the commit process. The current user may commit their version of the design to the shared file, creating a third version 36 of the shared file. All of the elements marked as conflicting in the second version 34 of the shared file are rejected and replaced with the revised version from the local copy 30′. The current user's version 30′ of the design file now becomes the current tip 36 of the shared file.

Note that this refresh-local-copy and update-server-copy mechanism has the effect of serializing changes to the shared file. Each local copy in turn is merged with the accumulated changes of others, and then the net local changes are used to update the shared file to a new revision. In particular, a user may always merge with accumulated changes in the server copy of the shared file, never with another user's local copy. Questions such as “what if three users change the same elements at the same time” are effectively reduced to a linear sequence of merges and updates. The first user to update the shared file creates the first revision in the shared file. The other two users must merge with that. The second user to update the server copy creates the next revision in the shared file. The third user must merge with that (thus, merging two revisions overall). The remaining user then updates the shared file to create the third revision. As each user refreshes his local copy, conflicts may be detected, and the user may or may not resolve those conflicts. Unresolved conflicts become part of the user's changes to the shared file, as described above.

Unit of Change

A unit of change defines the scope or extent of a change. Units of change are those portions of the different versions of the design file that are compared for determining conflicts. The unit of change enables the refresh process to detect when changes made to a local version of the file overlap with changes made by others to the shared file, which signals a conflict. By default, the unit of change may be set to the element level. When two users change the same atomic element, their changes conflict. When two users change a component of the same complex element, their changes conflict.

Beyond this, a user or application may define a unit of change that includes more than one element. Tools may be provided to allow a user or application to mark areas of the design, identify types of elements, or otherwise define the unit of change. Embodiments of the invention allow a user or application to define the unit of change.

During the refresh process those elements that have been changed in the local copy or shared copy of the file are detected. This may be done examining the attributes of the elements. If the refresh process detects changes in the shared file to any elements in the defined unit of change and local changes to the same or other elements in the defined unit of change, the shared file changes are rejected as conflicts. Even if the same element within the unit of change is not modified, all changes within the defined unit of change may be marked as conflicts. For example, a user can identify a set of elements in a spatial area as a unit of change. This may be done by defining an area, such as a square, in the design. The square may be created using a fencing tool common to many software applications. Changes made to any element within the square in both the local and shared copy of the file indicates a conflict. All the elements within the square may be treated as one for purposes of conflicts.

Logical groupings of elements created according to application-specific design rules may also be defined as the unit of change. The grouping may be created by an application. For example, a group of elements may make up a door, a process line or a property boundary. The elements comprising the door, etc. are identified and grouped together. If the refresh process detects changes at the shared file to some elements in that group and local changes to the same or other elements in the same group, then the shared file changes may be rejected as conflicts. Other unit of change policies may include, for example: all and same-model. Grouping elements together into logical design entities allows the user or application to prevent change-merging from mixing up elements from two competing designs. By preventing a mixture, two alternate, coherent versions of the design entity may be preserved in the design history.

Normally, overlapping changes to the same element are rejected as conflicts, and changes to different components of the same complex (aggregated) element are rejected as conflicts on the overall complex element. Special-purpose logic may be used to merge overlapping changes to the same element. This is especially useful in the case of complex elements. For example, if a complex element represents a table of dimension styles, two users should be able to add new styles without triggering a conflict. Custom application logic can merge these two changes into the complex element and to mark the complex element as not a conflict. More elaborate merging logic involving multiple atomic elements is also possible.

Patching

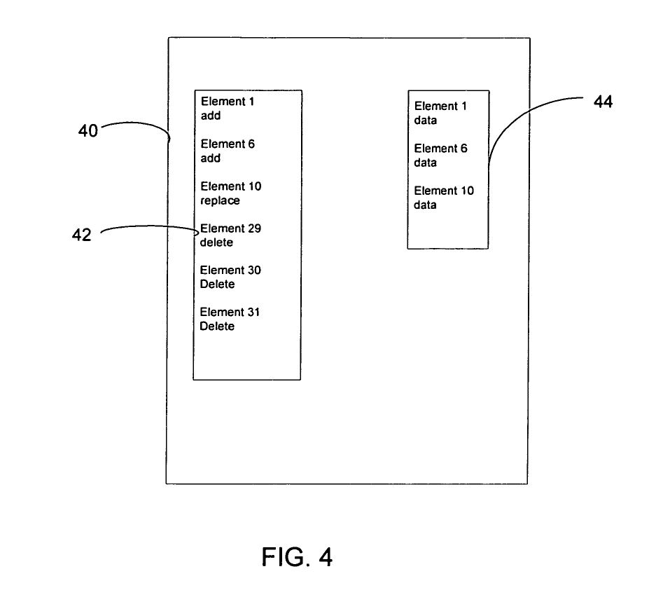

Patching is the process of modifying a file to include changes made to another copy of the file, for example during the refresh and update procedures. In embodiments of the invention, patching may be done as follows. A patch file 40 may include of an array of change records 42, plus an array of element copies 44, as shown in FIG. 4. A change record 42 identifies an element or a model and specifies a type of change, including add, replace, and delete. An element copy is a copy of an element's data. There should be an element copy for each change record specifying an add or a replace. In the case of a change record 42 that identifies a complex element, there is a single element copy of the complex element containing all of the components. The patch process steps through the array of change records 42 and replicates the changes to the specified file. Specified changes may be made at the element or model level. To add an element, the element copy from the change record is read and added to the file. For a replace, the element copy from the change record replaces the existing element, if any, in the file. For a delete, the existing element is deleted, if any, in the file.

When a change record identifies a model, the process may perform model-level add and delete operations. When a model-level add change record is encountered, the patch process creates an element model, reads the model header element from the element copies, and writes the model header element to the new model. A model-level add change record should always be followed by a series of element-level add change records. These element-level adds populate the new model. When the patch process encounters a model-level delete change record, the model is deleted. Any subsequent element-level change records that pertain to that model are ignored. When the patch process encounters a model-level replace change record, the model header element is read from the element copies and the model's header element is replaced with the new model header element.

Change Notification

A user of a shared file may be notified when updates are made to the shared file. In embodiments of the invention, the client program 24 polls the server while a user is editing a local copy of the file in order to find out if other users have updated the shared file. When the polling detects a change, the client program 24 notifies the user that new changes are pending. The user then knows that the local copy should be refreshed before the shared file may be updated with their local changes. A preview of the new changes may also be provided to the user, without refreshing. To get a preview, the client asks the server for the new changes as usual. However, instead of patching the local copy with the changes, the client merely displays them. The client can also query and display the name of the user(s) that made the changes to the server, as well as the descriptions of those changes.

Shared File History Queries

The design history of the shared file may be presented to a user. As stated above, the local file copy may not contain the design history of the shared file, but only the local changes. Therefore, a shared file history query must be satisfied by the server in order to present the design history to a user. For efficiency, however, query results may be cached, both on the client and on the server. In embodiments of the invention, the client program 24 executes a history query to obtain the design history. Note that recovering a historical version of a set of elements or a file begins with a history query.

In an exemplary embodiment, a history query specifies a file, the type of information required, and parameters that further specify the result. All information needed to execute the query may be contained in the query request. Therefore, a query may be stateless, idempotent, and can be cached. This makes the history query design ideal for a WAN, where individual communication transactions are slow and unreliable.

Query Cache

Query results may be saved in a cache. The results for a particular query may be saved in a file with a name equal to the cryptographic hash of the query parameters. Using a hash guarantees a reliable mapping from parameters to file name.

Query cache files may also contain a code that specifies the lifetime of the results. For remote query results, this code may be a 1, indicating the results are permanent, or 0, indicating the results are temporary. Temporary results may be good for a predetermined time, such as 10 minutes, and then discarded.

For local query results, the lifetime code may be 1, indicating the results are permanent, or 2, indicating the results are dependent on the tip revision. Other codes may also be used, for example to specify on what type of information the query result depends. This approach enables the local software to know what cached results depend on information that it is changing and to delete those cached results. Thus, local cache results may not necessarily time out, but can persist indefinitely, as long as the underlying information is not changed.

An upper limit on the number of files and the total number of files that can accumulate in a query cache may be set. A standard LRU (least recently used) algorithm may be used to prune the cache, as is known in the art.

In order to prevent the accumulation of too many files in a single cache directory, a two level cache naming scheme may be used. A first level is a directory name and a second level is a filename within a directory. The directory name may be computed using a technique similar to a standard hash table (not to be confused with a cryptographic hash).

Client Query Execution

When executing a particular history query, the client may first check its local cache for the saved results of an identical query. If the local cache contains the results, the client may then check that the results are still fresh. If so, the results may be returned directly from the client cache. Otherwise, the client may send the query on to the server. When the client receives the result from the server, the client may first save the result it in its local cache (for next time), and then return the results to the local caller.

Server Query Execution

When the server receives a design history query from the client, the server first checks its cache for saved results. A process similar to that used by the client may be used. A difference may be that the cache results are local for the server. Therefore, cache results are actively removed by the server when the information on which they depend is changed. If the server finds the cached result, it returns the cached result to the client. This reduces the computing load on the server. If the cached result is not present, the server opens the specified file and queries its design history to compute the result. The server then saves the result in its local cache and then sends it to the client.

N-Tier Projects

A new kind of “fast-track” design is possible if two designers can collaborate on the same drawings with fewer restrictions. At certain points in a project, changes must be shared. At other points, changes must be isolated. Sharing must sometimes occur within a project and sometimes across projects. Projects must sometimes be isolated from each other and from the master documents. Projects A and B are considered to be “tiers” of a hierarchy of projects. It is possible that sub-projects could be branched off of project A. Thus, there can be many levels to such a hierarchy, hence the term “n-tier.”

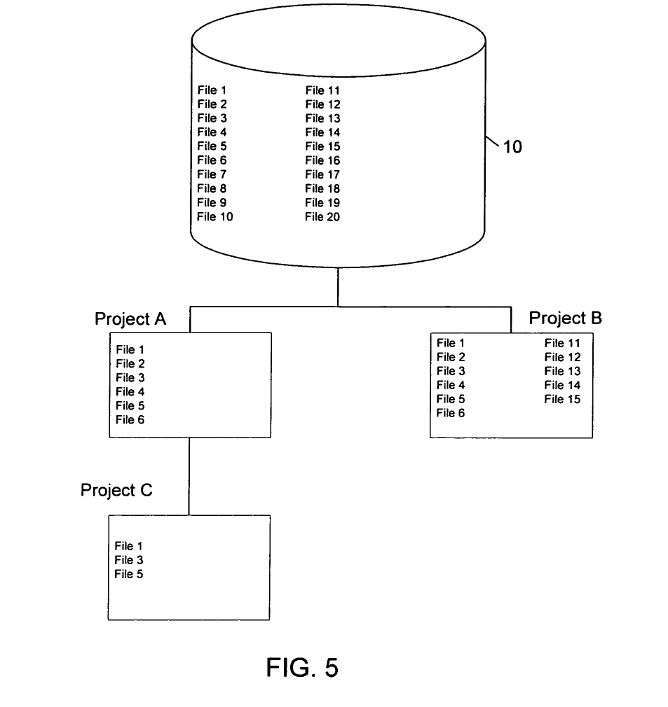

The file based data stored in the data store 10 may be checked out and arranged in a hierarchical project. For example, referring to FIG. 5, the data repository stores the master copy of files. The files in the data repository are shared files that may be accessed and copied by a plurality of different users. A number of different projects that each include data files from the data repository may be set up. A local copy of each shared file that is part of a project is checked out from the data repository.

For example, project A includes copies of files 1-6 from the data repository. Project B may also include copies of files 1-6 plus additional files 11-15. Users may check out and create local copies of the files resident in project B in order to work on the project. The files resident in project A and project B may also be shared files that are accessible by a plurality of users. Additional nested projects may be created based on projects A and B. For example, as shown in the Figure, another project, project C is nested underneath project A. Project C is a collection of shared files 1, 3 and 5 derived from project A. Users may check out files of project C in order to work on the design. Additional levels of nesting may be provided all the way down to level N. Each of the nested copies of the file is marked to indicate its relationship to higher levels in the hierarchy.

A local copy of the shared file that is part of a project is checked out from a higher level in the hierarchy. It is possible to change the scope of a project that is in progress by checking out additional shared files or releasing local copies. These local copies may be imported into a project specific folder. The imported copies retain their connection to their original (parent) shared files.

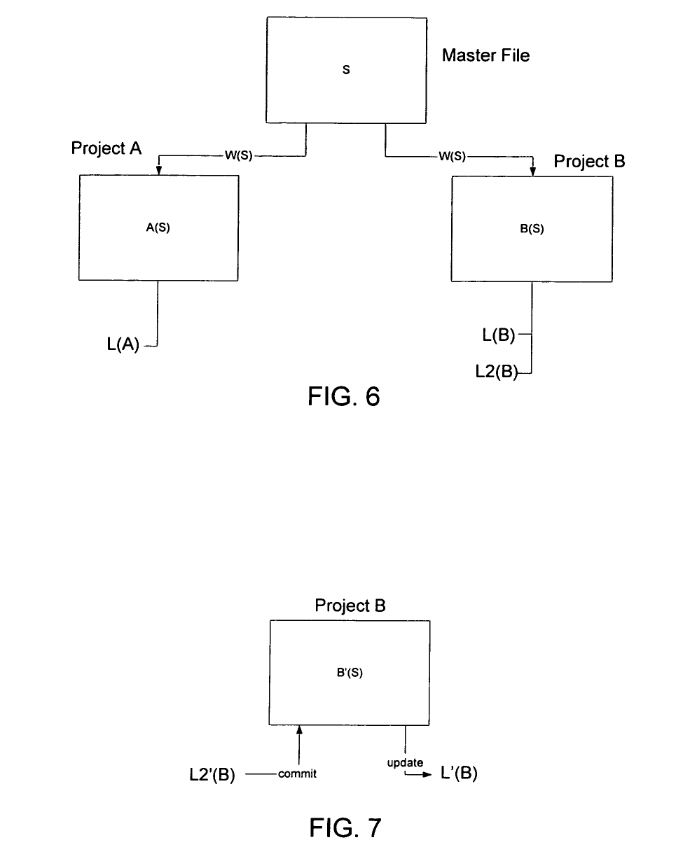

FIG. 6 illustrates an example of files and their relations after two projects, project A and project B are created. The master document S resides in a folder called master documents in the data store. When a copy of S is checked out, a temporary local copy derived from document S called W is created. The notation W(S) indicates that W is marked as a local copy of S. W(S) is imported into a new folder called project A and is renamed A(S). The notation A(S) indicates that the file is marked as a local copy of S. The notation for project B follows the same pattern. A file B(S) is placed in a folder for project B. The temporary local copy W may only be used for the purposes of setting up the projects and then discarded.

The files in project A folder and in project B folder are shared files. Once the desired files are copied into the appropriate project folders, users are able to check out and work on the files. When a user on the project A team wants to work on a document, the user checks out a local copy from the project A folder. When a member of the project B team wants to work on a document, that user checks out a local copy from the project B folder. Thus, projects A and B are isolated from each other as is illustrated in the Figure. A local copy L(B) is created for document B(S) and a local copy L(A) is created for local copy A(S). In the Figure, L is the local copy used by the member by of project A. The notation L(A) indicates that L is marked as a local copy of A. Thus, there is a link from project A working copy back to the original master document L(A(S)). Note that A is simultaneously a shared file in its own right and a local copy of shared file S. The notation and relations for the local copy in project B follow the same pattern. Note that the local copy L(B) in project B is physically distinct from the locally copy L(A) in project A and is linked to a different shared file.

When a second member of the project B team checks out file B, a second local copy is made against B. Accordingly, there is file L(B) and file L2(B). Each of these local copies is distinct from each other and is tied by the same shared file B in project B. When either team member of project B commits its changes to the shared file B(S), file B is updated. Other members of project B are then able to update their local copies of file B.

FIG. 7 illustrates an example of changes made to file L2(B) committed to project B. In the Figure, L2′(B) is the changed version of L2(B). When the L2′(B) changes are committed, file B in the project B folder is updated. A new version of B, B′ is created. The first user's local copy of B is then updated, creating version L′(B) which results from the updating of L after the commit of L2. Project A is unaffected by the changes. In this manner, users within project B are able to share their work without affecting the documents in project A or the master document S. Project B may continue and numerous revisions and updates to file B may be created. When project B is finished, a copy of file B may be extracted from project B, set up as a local copy of S and committed to the master document folder.

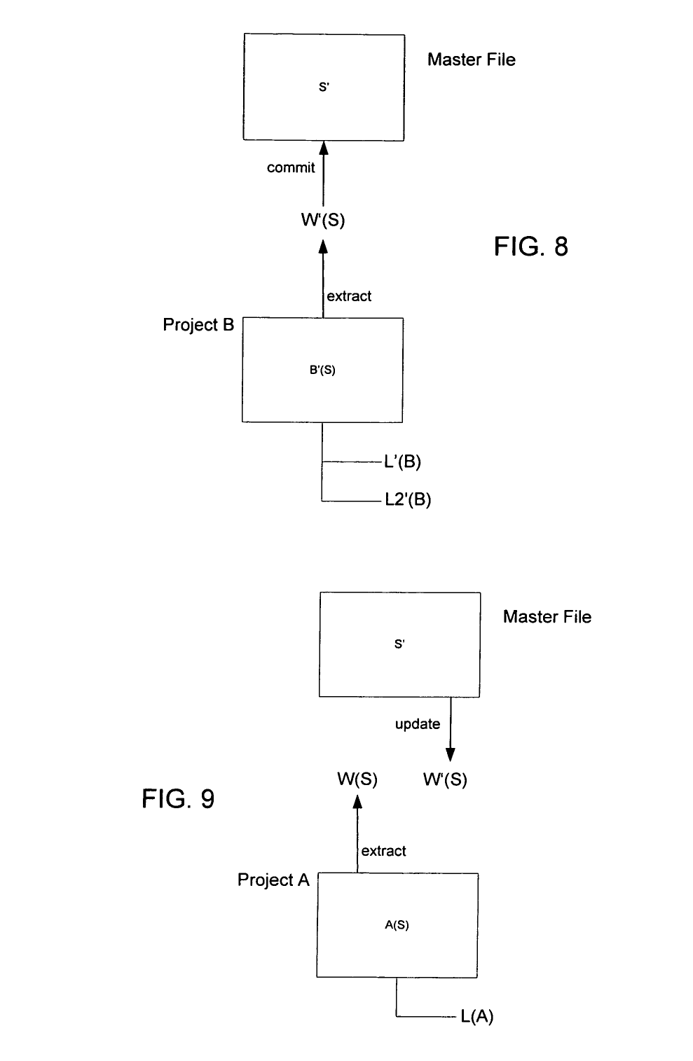

FIG. 8 shows an exemplary process for committing the changes from project B to the master document folder. In the Figure, W′ is a temporary copy of B′. The notation W′(S) indicates that, as a copy of B′, W′ is marked as a local copy of S. W′ is then committed to the master document folder, updating S. S′ is the updated version of S. After the changes to project B have been committed to the master document folder, project A must be updated at some point to incorporate the changes committed by project B to the master document S.

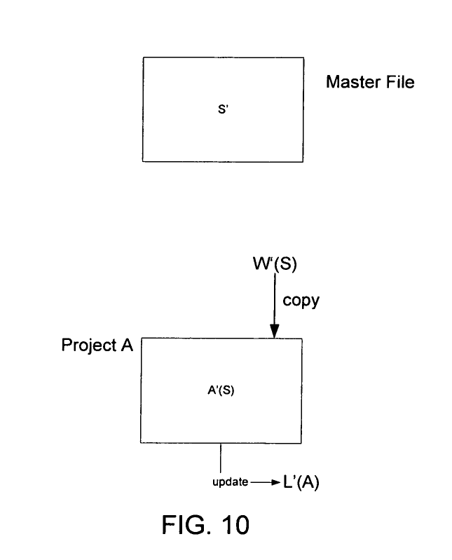

FIGS. 9 and 10 illustrates an exemplary process for updating the files of project A. A copy of file A(S) is extracted from the project A folder. The extracted copy is indicated by W(S), indicating that W is a temporary copy of S. A temporary copy of S is updated with the changes of the updated version S, S′ prime. The copy of A in project A folder is replaced with the updated copy resulting in A′(S) being saved in the project A folder. Note that L(A) an outstanding local copy of A, remains unaffected when A is updated. L(A) remains linked to file A nonetheless. Since A has been updated, L is now out of date and must be updated from A. The changes from file A′(S) are then patched to file L(A), resulting in L′(A) which is the updated of L(A). At this point, the changes originally committed by project B have migrated all the way down to L(A).

In order to update L(A) from A(S), A must be a shared file. Specifically, file A must contain a history of changes that occurred since L was derived from file L or was last updated. In the scenario described above, the changes that occurred are changes to the master document S. As a local copy A(S) would not normally contain a history of changes to master document S. Instead, A(S) would access that history directly from S. Being a shared file, file A is not a normal local copy. It is also a shared file. As a shared file, file A must present a complete history of the project to its local copies, including both changes by other projects to master document S and local changes to project A. Therefore, file A must replicate the history of master document S from the start of the project onward.

Embodiments of the invention may be used in many different practical situations. Embodiments of the invention may be used to update CAD standards while a project is in progress. An example of the use of CAD standards is described in co-pending U.S. application Ser. No. 10/274,117, entitled “SYSTEM, METHOD AND COMPUTER PROGRAM PRODUCT FOR MANAGING CAD DATA”, which is incorporated herein by reference.

Briefly, engineering drawings display graphics, but a drawing is more than a picture. The drawing identifies real-world things, shows how one part of a drawing is related to another part, and conveys engineering information such as status, location, purpose, and material, among other things. In order to convey such information, engineering drawings must use a graphical “vocabulary” that is understood by the project participants. The vocabulary is defined by what are called CAD standards. CAD standards including simple graphical attributes like color, weight, and style, plus organizing features such as level/layer, as well as libraries of symbols/cells. Draftsmen use a prescribed set of styles, levels, and cell libraries in a prescribed way in order to create drawings that convey engineering information clearly.

In some cases, CAD standards must be updated while a project is in progress. A common problem arises when two subcontracting groups within the same project use slightly different standards. Those standards must be merged and reconciled in order to combine their work. In order to do this, the standards definitions must be changed, and the graphics drawn with reference to those definitions must be refreshed.

Embodiments of the invention may be utilized to update CAD standards and refresh the graphics that use them while project work is in progress. An administrator may update the design files that contain the standards definitions. In some cases, the administrator must also modify the drawings that use the standards in order to “push” these changes out to the graphics that use them. Meanwhile, the other draftsmen in the project may continue working on the drawings that depend on the standards, possibly including some of the drawings that were modified by the administrator. Once the administrator's change is finished, the local copies of the design files are refreshed, for example as described above, in order to receive the updated standards. Thus, the standards updates are propagated to the working files in use by the draftsmen, without any loss of work or slow down in the project. The administrator function may override any conflicts with the local copy of the file.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

We claim:

1. A method comprising:
creating a local copy at a local computer of a shared file;
receiving user input at the local computer modifying the local copy;
updating the local copy with changes made to the shared file since the local copy was created;
detecting conflicts between the local copy and the changes made to the shared file;
marking the conflicts in the local copy;
updating the shared file to include changes made to the local copy without requiring the conflicts to be resolved, the local copy replacing the conflicts in the shared file;
storing the conflicting version of the shared file in a history.

2. The method of claim 1, further comprising detecting conflicts based on a user defined unit of change.

3. The method of claim 2, further comprising detecting the conflict when an element within a unit of change is modified in the local copy and a same or other element within the same unit of change is modified in the shared file.

4. The method of claim 3, further comprising:
determining if the conflict is solely based on a modification to a redundant property of the element; and
filtering the conflict based on a result of the determining step.

5. The method of claim 1, further comprising:
defining a unit of change; and
detecting conflicts between two versions of a file based on the unit of change.

6. The method of claim 5, further comprising detecting a conflict if a change has been made in either version of the file within the unit of change.

7. The method of claim 5, wherein defining the unit of change comprises selecting a group of elements in the file as the unit of change.

8. The method of claim 5, further comprising designating an area of the design as a unit of change.

9. The method of claim 5, further comprising defining a level as a unit of change.

10. The method of claim 5, further comprising changing an attribute of an element to indicate the element is within the unit of change.

11. The method of claim 5, further comprising:
tracking elements changed in a version of the file; and
determining if any of the elements are within the unit of change; and
indicating the conflict when the elements are within the unit of change.

12. The method of claim 5, further comprising receiving user input defining the unit of change.

13. The method of claim 5, further comprising receiving application input defining the unit of change.

14. The method of claim 1, further comprising:
identifying related elements in the local file;
determining if changes have been made to the related elements either in the shared file or in the local file; and
modifying the related elements in the local file to be consistent with each other.

15. A method for resolving conflicts between versions of a file, comprising,
receiving user input defining a boundary defining a conflict area;
detecting conflicts between versions of a file based on changes made to elements within the conflict area;
marking the conflicts in one of the versions of the file;
saving the one version of the file as the current version, including the conflicts; and
saving the other version of the file in a history.

16. The method of claim 15, wherein the current version is a shared file accessible to other users.

17. A method for sharing and isolating changes made to shared files, comprising:
creating at least one shared file that is accessible to plural users;
creating at least one second tier arranged in a hierarchical fashion under the shared file, the second tier including at least a first file and a second file, which are copies of the shared file, the first and second files being accessible to plural users;
linking the first and second files to the shared file;
creating a local copy of the first file on a client device;
editing the local copy of the first file at the client device;
committing the edited copy to the first file, without changing the second file;
committing a changed version of the first file to the shared file; and
subsequently updating the second file to reflect changes made to the shared file.

18. The method of claim 17, further comprising detecting conflicts between the local copy and the second tier copy of the file.

19. The method of claim 17, further comprising detecting conflicts between the master copy and a sub tier copy.

20. The method of claim 17, further comprising providing an alert to users when changes are made to the shared file.

21. A method of updating design files while a project is in progress, comprising:
modifying a shared file to reflect changes made to a project standard using an administrator function;
refreshing a local copy of the shared file to reflect the changes made to the project standard.

22. The method of claim 21, wherein the project standard comprises one of a CAD standard and as-built drawing and further comprising applying the modified CAD standard to the local copy.

23. The method of claim 21, wherein the modifications are made using an administrator function that overrides any conflicts in the local copy.

24. The method of claim 21, wherein the refreshing step comprises updating the local copy with changes made to the shared file since the local copy was created

25. The method of claim 21, wherein the shared file is a cell library and further comprising receiving modifications to the cell library via user input at a local computer and storing the modifications in the cell library.
